(19) United States
(12) Patent Application Publication
(10) Pub. No.: US 2025/0363252 A1
(43) Pub. Date: Nov. 27, 2025

(54) INFORMATION PROCESSING DEVICE

(71) Applicant: SONY GROUP CORPORATION, TOKYO (JP)

(72) Inventors: NAOYA SAZUKA, TOKYO (JP); KOKI KATSUMATA, TOKYO (JP)

(21) Appl. No.: 18/875,133

(22) PCT Filed: Jun. 8, 2023
(86) PCT No.: PCT/JP2023/021350

§ 371 Date: Dec. 14, 2024

(30) Foreign Application Priority Data
Jun. 23, 2022 (JP) 2022-101209

(51) Int. Cl. G06F 21/84; G06F 3/01

(52) U.S. Cl. CPC G06F 21/84; G06F 3/011; G06F 2221/032

(57) ABSTRACT

An information processing device according to one embodiment of the present disclosure includes, an acquisition unit configured to acquire of a first information related to a living body, a generation unit configured to generate of a second information related to a degree of concentration of a user on the basis of the first information, and a control unit configured to control time to suspend output of content on the basis of the second information.

### TECHNICAL FIELD

The present disclosure relates to an information processing device.

### BACKGROUND ART

There have been several proposals for an information processing device, which prohibits processing of notifications while a user is sleeping or when a degree of concentration of the user is not less than a predetermined level (see Patent Literature 1).

### CITATION LIST

### Patent Literature

Patent Literature 1: Japanese Unexamined Patent Application Publication No. 2017-69687

### SUMMARY OF THE INVENTION

It is desirable that a device for performing a notification control enables appropriate control in accordance with circumstances.

It is desirable to provide an information processing device that allows for a suitable control.

An information processing device according to one embodiment of the present disclosure includes, an acquisition unit configured to acquire of a first information related to a living body, a generation unit configured to generate of a second information related to a degree of concentration of a user on the basis of the first information, and a control unit configured to control time to suspend output of content on the basis of the second information.

### BRIEF DESCRIPTION OF THE DRAWINGS

FIG. 1 is a diagram illustrating a configuration example of an information processing system according to an embodiment of the present disclosure.

FIG. 2 is a diagram explaining a configuration example of an information processing device according to the embodiment of the present disclosure.

FIG. 3 is a diagram illustrating an example of image displayed by a display unit of the information processing device according to the embodiment of the present disclosure.

FIG. 4 is a diagram illustrating an example of image displayed by the display unit of the information processing device according to the embodiment of the present disclosure.

FIG. 5 is a diagram illustrating an example of image displayed by the display unit of the information processing device according to the embodiment of the present disclosure.

FIG. 6 is a diagram illustrating an example of image displayed by the display unit of the information processing device according to the embodiment of the present disclosure.

FIG. 7 is a diagram illustrating an example of image displayed by the display unit of the information processing device according to the embodiment of the present disclosure.

FIG. 8 is a diagram illustrating another example of image displayed by the display unit of the information processing device according to the embodiment of the present disclosure.

FIG. 9 is a flowchart illustrating an example of actions of the information processing device according to the embodiment of the present disclosure.

### MODES FOR CARRYING OUT THE INVENTION

Hereinafter, an embodiment for practicing the present disclosure is described in detail with reference to the drawings. It is to be noted that description is given in the following order.

### 1. Embodiment

### 2. Modification Examples

### 1. Embodiment

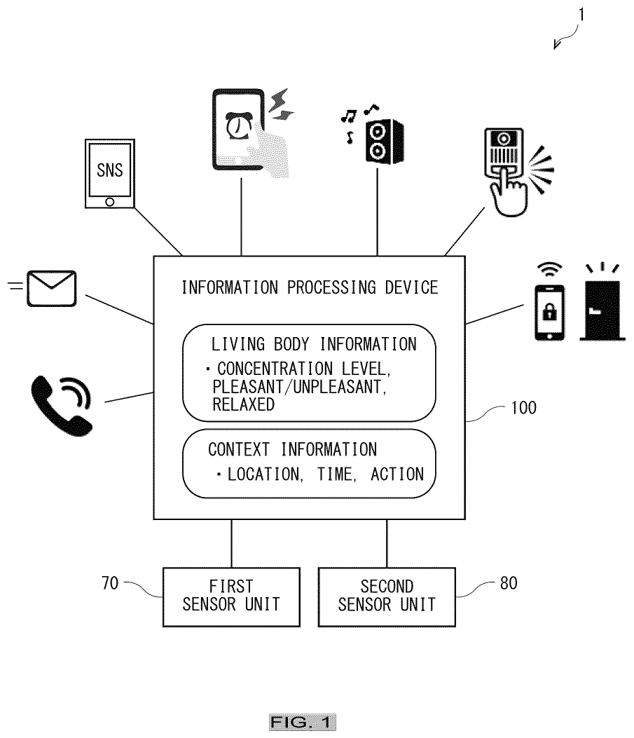

FIG. 1 illustrates a configuration example of an information processing system according to an embodiment of the present disclosure. An information processing system 1 includes an information processing device 100, a first sensor unit 70, and a second sensor unit 80. The information processing device 100 is a terminal device (terminal) used by a user. The information processing device 100 is an electronic apparatus, that is, for example, a smartphone, tablet terminal, wearable terminal, computer, or the like.

The information processing device 100 is configured to be connectable to a network, allowing communication with external apparatuses, servers, or the like. The information processing device 100 is configured to control external apparatuses by IoT technology. For example, as illustrated in FIG. 1 schematically, the external apparatus may be a peripheral apparatus of the user, such as an intercom, speaker, landline phone, door locking device, or the like.

The first sensor unit 70 is configured to allow generation of information related to a living body (hereinafter referred to as “living body information). The first sensor unit 70 is a sensor configured to acquire of the living body information (“living body sensor”), which is wearable on the ears, head, hands, feet of the body of user. With reference to the information processing system 1, the user wears the first sensor unit 70, to detect the living body information. The first sensor unit 70 is an optical sensor, potential sensor, or the like, configured to generate the living body information. The living body information is, for example, information related to an internal state of a human body as the living body.

The living body information includes, for example, information related to pulse wave, information related to brain wave, information related to perspiration rate, information related to blood flow rate, information related to myoelectric potential, information related to skin temperature, or the like. The first sensor unit 70 allows inclusion of various sensors having ability of acquiring the living body information. It is possible that the first sensor unit 70 includes, for example, a brain wave sensor, perspiration sensor, blood flow sensor, myoelectric potential sensor, temperature sensor, or the like. It is also possible that these sensors are installed in a headphone, earphones, watch, glasses (eyeglasses), or the like.

The second sensor unit 80 is configured to allow generation of information related to a state and/or a condition of user (hereinafter referred to as “context information”). The information related to the state includes, for example, information related to an action (motion) of user, information related to a location of user, information related to the time, information related to sound, or the like. It is possible that the second sensor unit 80 includes various sensors, for example, an acceleration sensor, gyro sensor (angular velocity sensor), GPS sensor, sound sensor, or the like, which allow acquisition of the context information.

The information processing system 1 acquires the living body information and the context information, that makes it possible to be used for control of the information processing device 100 and peripheral apparatuses. Note that, the information processing device 100, the first sensor unit 70, and the second sensor unit 80, may be collectively referred to as the information processing device. It is also possible that a part or all of the information processing device 100, the first sensor unit 70, and the second sensor unit 80. is formed integrally.

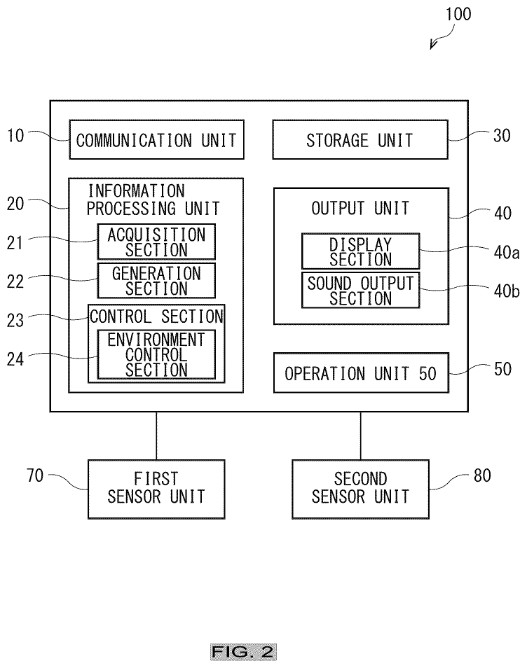

FIG. 2 is a diagram explaining a configuration example of the information processing device according to the embodiment. The information processing device 100 includes, a communication unit 10, an information processing unit 20, a storage unit 30, an output unit 40, and an operation unit 50. The communication unit 10, the information processing unit 20, the storage unit 30, the output unit 40, and the operation unit 50, allow transmission and reception of information by cable communication or wireless communication.

The communication unit 10 includes a communication module, and is configured to allow communication with the external apparatuses. The communication unit 10 includes a transmitting section and a receiving section, and performs transmission and reception of information, for example, communication data, email, message, chat, the living body information, and the context information, or the like. In the example as illustrated in FIG. 1 and FIG. 2, the communication unit 10 receives the living body information from the first sensor unit 70, by communicating with the first sensor unit 70. Moreover, the communication unit 10 allows reception of the context information from the second sensor unit 80, by communicating with the second sensor unit 80.

The information processing unit 20 includes a processor and a memory (ROM, RAM, or the like), and is configured to perform various types of information processing. The information processing unit 20 loads and executes programs installed therein, and performs information processing (signal processing). The information processing unit 20 may be referred to as a signal processing unit. Moreover, the information processing unit 20 also serves as a control unit, and performs control of respective units of the information processing device 100 on a basis of the program. Moreover, the information processing unit 20 performs information transmission/reception communication with the peripheral apparatuses via the communication unit 10, or the like, and allows control of the peripheral apparatuses.

The storage unit 30 is configured to include a nonvolatile memory, and memorizes (records) program and data. The storage unit 30 stores various types of information, for example, the program and data used for the control of various units of the information processing device 100, and the program and data for various applications. The storage unit 30 is a storage medium, for example, a semiconductor memory, hard disc, or the like.

The output unit 40 includes a display section 40a is configured to display of images, and a sound output section 40b enabling output of sound. The display section 40a is a liquid crystal display, organic EL display, or the like, and is configured to display images on a basis of image data. It also is possible for the display section 40a to include a touch panel. The sound output section 40b is configured to output sound on a basis of audio data.

The operation unit 50 includes, for example, a touch panel, keyboard, or the like, and is configured to be acceptable of operation with regard to the information processing device 100. The operation unit 50 is configured to output signals on a basis of operation (operation signals) in accordance with operation by the user. The operation unit 50 allows output of the operation signals for various functions provided by the information processing device 100. Hereinafter, the information processing unit 20 according to the embodiment of the present disclosure will be explained further in detail.

As illustrated in FIG. 2, the information processing unit 20 includes an acquisition section 21, a generation section 22, and a control section 23. The acquisition section 21 is configured to acquire, the living body information related to the living body, the context information related to the state and condition of the user, the operation signals, or the like. The acquisition section 21 acquires, for example, the living body information and the context information via the communication unit 10. Moreover, the acquisition section 21 acquires the operation signals on a basis of operation by the user, from the operation unit 50.

In the example as illustrated in FIG. 2, the acquisition section 21 acquires the living body information from the first sensor unit 70, and also acquires the context information from the second sensor unit 80. The living body information and the context information are generated regularly or irregularly by the first sensor unit 70 and the second sensor unit 80, respectively, and are outputted to the acquisition section 21 via the communication unit 10. The acquisition section 21 may also be referred to as an input section, into which the living body information and the context information are inputted.

The generation section 22 is configured to allow generation of information related to a degree of concentration of the user (hereinafter referred to as “concentration level information”). The generation section 22 generates the concentration level information, which is related to the degree of concentration of the user, on a basis of the living body information acquired by the acquisition section 21. The concentration level information includes, for example, information showing the degree of concentration of the user in a work such as a task, information showing the degree of concentration of the user in entertainments such as movies, or the like. The concentration level information may also be referred to as information showing whether or not the user is concentrating.

The information processing unit 20 of the present embodiment is configured, by using the living body information, to judge the degree of concentration and a degree of vigilance of the living body, and to allow generation of the concentration level information. The living body information enabling judgment of the degree of concentration and the degree of vigilance of a subject living body includes, for example, information related to perspiration, brain wave, pulse wave, cardiac potential, blood flow, skin temperature, mimetic muscle electric potential, eye electric potential, saliva, or the like. The first sensor unit 70 is configured to include sensors allowing acquisition of these types of information. The generation section 22 of the information processing unit 20 calculates the degree of concentration, for example, on a basis of the living body information, and enables generation of the concentration level information showing the degree of concentration.

As an example, the generation section 22 calculates the degree of concentration by using cardiac rate included in the living body information, and generates the concentration level information showing the degree of concentration. In this case, it is also possible for the generation section 22 to calculate the degree of concentration by comparing the cardiac rate with a reference value. It is generally understood that, the higher the cardiac rate, the higher the degree of vigilance. Thus, in a case where the cardiac rate is higher than a predetermined threshold, it is possible for the generation section 22 to assume that the degree of vigilance of the living body is high, and the degree of concentration of the living body is high. Moreover, in a case where the cardiac rate is lower than a predetermined threshold, it is possible for the generation section 22 to assume that the degree of vigilance of the living body is low, and the degree of concentration of the living body is low. The generation section 22 enables generation of the concentration level information showing the assumed degree of concentration of the living body.

Moreover, for example, it is also possible that the generation section 22 calculates the degree of concentration by using information on brain wave (components of the alpha wave and the beta wave) included in the living body information, to generate the concentration level information. It is known that, the component of the alpha wave included in the brain wave increases when the living body is in a relaxed (for example, resting) state, and the component of the beta wave included in the brain wave increases when the living body is active and under vigorous thinking, or when the living body is concentrating. Thus, for example, in a case where a power spectrum area of frequency band of the alpha wave is smaller than a predetermined threshold th1, and at the same time, in a case where a power spectrum area of frequency band of the beta wave is larger than a predetermined threshold th2, then, it is possible for the generation section 22 to assume that the degree of vigilance and the degree of concentration are high.

It is also possible that the generation section 22 calculates the degree of concentration by using information on perspiration rate included in the living body information, to generate the concentration level information. It is also possible that the generation section 22 calculates the degree of concentration by comparing the perspiration rate with a reference value. For example, it is possible that the generation section 22 calculates the degree of concentration of the living body, by using signal voltage corresponding to psychogenetic perspiration acquired by a probe of perspiration meter attached on the palm or the sole of the living body. In a case where a value of high frequency component or a value of low frequency component among the signal voltage is higher than a predetermined threshold, then, it is also possible for the generation section 22 to assume that the degree of vigilance of the living body is high, and to assume that the degree of concentration is high.

Moreover, for example, it is also possible that the generation section 22 calculates the degree of concentration by using information on skin temperature included in the living body information, to generate the concentration level information. It is also possible that the generation section 22 calculates the degree of concentration by comparing the skin temperature with a reference value. It is generally understood that, the higher the skin temperature, the higher the degree of vigilance. Thus, for example, in a case where the skin temperature measured by a thermography is higher than a predetermined threshold, it is possible for the generation section 22 to assume that the degree of vigilance and the degree of concentration are high.

It is also possible that the generation section 22 calculates the degree of concentration on a basis of image data acquired by photographing of the living body, to generate the concentration level information. For example, it is also possible that the generation section 22 assumes a facial expression of the user by using the image data acquired by a camera, to assume the degree of vigilance and the degree of concentration in accordance with the facial expression. Note that, it is also possible that the generation section 22 calculates frequency of blinking on a basis of moving image data, to assume the degree of vigilance and the degree of concentration in accordance with the frequency of blinking.

Note that, the judgment methods of the degree of concentration are not limited to the methods described above. It is also possible that the generation section 22 calculates the degree of concentration on a basis of blood flow rate, mimetic muscle electric potential, eye electric potential, respiration amount, respiration speed, audio data, or the like, to generate the concentration level information. It is also possible that the information processing unit 20 assumes the degree of concentration, the degree of vigilance, or the like, by using an assumption model (learning model, or the like).

The generation section 22 repeatedly generates the concentration level information, by using the living body information, or the like, sequentially inputted from the first sensor unit 70 to the acquisition section 21. For example, the concentration level information may be information showing the size (value) of the degree of concentration, or may be information showing whether or not the degree of concentration is high. It is also possible for the concentration level information to include information showing the degree of vigilance of the user.

The control section 23 is configured to enable controlling of output of content on a basis of the living body information and the context information. In the present embodiment, it is possible that the control section 23 suspends or restricts an output of content liable to obstruct the concentration of the user, on a basis of the concentration level information generated by the generation section 22. For example, the control section 23 judges, by using the concentration level information, whether or not the degree of concentration of the user is high, to control the output of content in accordance with a judgment result. Moreover, for example, it is also possible that the control section 23 judges, by using the concentration level information, whether or not the user is in a state of concentration, to control the output of content in accordance with the judgment result.

As an example, in a case where the user is judged to be concentrating, the control section 23 suspends a content related to notifications to the user. For example, in a case where the degree of concentration shown by the concentration level information is not less than a predetermined threshold, the control section 23 judges that the degree of concentration is high, and suspends a content related to the notifications to the user. It is possible for the control section 23 to perform processing for prohibiting any notification content (telephone call, email, chat, or the like), by controlling the communication unit 10, the output unit 40, or the like. Moreover, for example, in a case where the degree of concentration of the user in working is judged to be high, the control section 23 suspends an image content, a telephone call content, or the like. Because the notifications to the user are suspended or restricted, it is possible to suppress obstruction against the concentration of the user.

Moreover, the control section 23 according to the embodiment of the present disclosure includes an environment control section 24, which allows control of surrounding environment of the user. It is possible for the environment control section 24 to control peripheral apparatuses of the user on a basis of the living body information and the context information. For example, the environment control section 24 supplies signals for controlling the peripheral apparatuses in accordance with the degree of concentration of the user shown by the concentration level information, to control actions of the peripheral apparatuses.

As an example, in a case where the degree of concentration of the user is judged to be high, or in a case where the user is judged to be concentrating, then, the environment control section 24 controls a door locking device, not to allow opening of a door of a room in which the user is staying. Moreover, for example, in a case where the degree of concentration of the user is assumed to be high, or in a case where the user is assumed to be concentrating, then the environment control section 24 controls an intercom, not to allow ringing of the intercom. As explained above, it is possible for the environment control section 24 to change the surrounding environment of the user according to the degree of concentration of the user, to provide an environment in which the concentration of the user is maintained. It is possible to suppress any interference with the concentration of the user.

In a case where the information processing device 100 is a headphone or earphone device, and when the user becomes concentrating, then, it is also possible for the control section 23 to control the sound output section 40b, or the like, not to allow any external noise to be heard by the user. Moreover, it is also possible for the control section 23 to slightly lower the volume of music content to which the user is listening. It is also possible for the environment control section 24 to control external speakers, to lower the volume of music.

Note that, the control of content and environment explained above is for a mere exemplification purpose, and it is possible for the information processing device 100 to perform various types of control. For example, in a case where the degree of concentration of the user is high, or in a case where the user is concentrating, then, it is also possible for the environment control section 24 to control a landline phone, not to allow ringing of the landline phone. In a case where the user is at office, it is also possible for the environment control section 24 to indicate a signal on a display, or the like, drawing attention not to talk to the user.

Note that, it is also possible for the information processing device 100 to control the sound output section 40b or the external speakers, to play the user's favorite music. It is also possible for the environment control section 24 to control a fragrance (scent) generator, to generate the fragrance around the user. While the user is sleeping, it is also possible for the control section 23 to control the sound output section 40b, to lower the volume of the sound output section 40b.

As explained above, according the information processing system 1 of the present disclosure, because of control of notifications and environment by detecting the state of concentration of the user, it is possible for the user to concentrate in working or entertainment experience. It is possible to prevent deterioration of working efficiency, such as that of task, or the like.

Note that, in a case where the control section 23 receives an emergency notification (emergency earthquake warning, building fire alarm, or the like), it is possible for the control section 23 to immediately notify the user by the display section 40a, the sound output section 40b, and the like. It is also possible for the control section 23 to detect, on a basis of the context information, whether or not an earthquake occurred, to cancel the control based on the concentration level information. It is possible to appropriately control notifications, or the like, by additionally evaluating the emergency level of notifications.

It is also possible for the information processing device 100 to allow setting of any notification to be designated as an exceptional processing. For example, it is also possible for the control section 23 to control the display section 40a and the sound output section 40b, or the like, to designate emails or telephone calls from a person (for example, a boss of the user) specified by the user in advance, as the subject for exceptional processing, and to notify the user immediately.

Moreover, it is also possible for the control section 23 to control output of content on a basis of the context information. For example, according to the context information, in a case where the user is assumed to be sitting during working hours, it is also possible for the control section 23, not to allow notifications to the user. Moreover, it is also possible for the control section 23, on specific days of the week (for example, Saturday, Sunday), not to allow notifications to the user in accordance with the degree of concentration of the user. It is also possible for the control section 23, not to allow notifications to the user, while the user is cooking, or after the user turns the light off.

Even in a case of a long-hour suspension of notifications or the like, there may be a situation that the user cannot continue the concentration. Thus, according to the present embodiment, the control section 23 is configured to allow changing of time of controlling on a basis of the concentration level information. It is possible that the control section 23 automatically sets, or the user appropriately sets, a start time of suspension of the output of content, an end time of suspension of the output of content, and a period of suspension of the output of content.

As an example, it is possible for the control section 23 to change the time for controlling content and/or environment in accordance with the degree of concentration of the user. For example, in a case where the user is judged to be concentrating, the control section 23 starts suspension of the output of content. It is also possible that, in a case where the user is concentrating for not less than a predetermined time, the control section 23 starts suspension of the output of content.

Moreover, in a case where the user is judged not to be concentrating, the control section 23 ends (cancels) suspension of the output of content. It is also possible that, in a case where the user is not concentrating for not less than a predetermined time, the control section 23 ends suspension of the output of content.

It is also possible, by operation of the operation unit 50, or the like, by the user, to enable setting of the start time of suspension of the output of content, the end time of suspension of the output of content, and the period of suspension of the output of content, as described above. Because of setting of a maximum time (upper limit time) for suspending notifications, intercom calls, or the like, it is possible, for example, to prevent obstruction against concentration during movie watching, lectures at university, or the like.

Note that, after the end of suspension of notification or the like, it is possible to notify information that was not notified during suspension. Moreover, it is also possible to notify “contact done” message to a person who tried to call or communicate to the user. Because of controlling of notification timing, it is possible to suppress missing of notified information. Moreover, it is also expected to relieve “smartphone addiction” in a natural way.

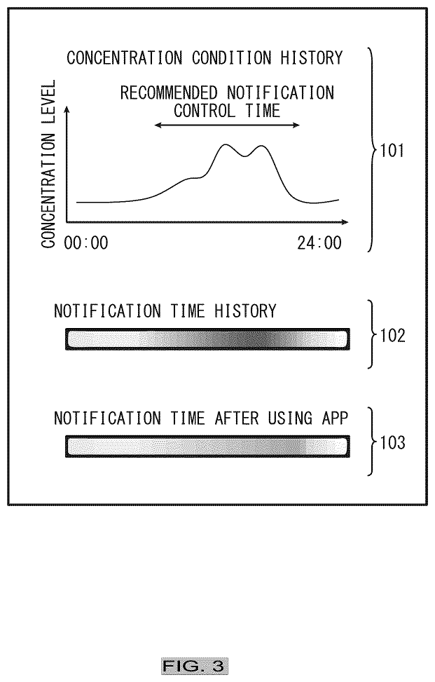

It is also possible for the information processing device 100, to set the time for controlling based on the concentration level information, on a basis of a brief history of past degree of concentration. As illustrated in an example of FIG. 3, it is also possible for the control section 23, to display an image 101 showing the brief history of concentration condition (concentration level), on the display section 40a. Thus, it is possible for the user to grasp, at what time the control should be done, or how long the control should be done, or the like, on specific days of the week, or during daytime. It is possible for the user to appropriately select the time for controlling based on the concentration level information.

Moreover, as illustrated in an example of FIG. 3, it is possible for the display section 40a, to display an image 102 serving as information showing brief history of past time for phone calls. In the example as illustrated in FIG. 3, the image 102 shows that there are frequent notifications during a period of time in which the user is concentrating, that is, the period of time in twenty-four hours, in which the degree of concentration of the user is high. Moreover, as illustrated in the example of FIG. 3, it is also possible for the display section 40a to display an image 103 serving as expected data of time for phone calls after using of an application software, that is after controlling on a basis of the concentration level information.

It is also possible for the information processing device 100, to set the start time of suspension of the output of content, the end time of suspension of the output of content, and the period of suspension of the output of content, on a basis of the brief history of past degree of concentration. It is also possible that the time for suspension or restriction of the output of content is adjusted automatically in accordance with the brief history of past degree of concentration. It is possible to effectively suppress obstruction against the concentration of the user.

Moreover, the information processing device 100 according to the present embodiment is configured to perform control in accordance with the concentration condition of the user. For example, it is possible for the control section 23 to change control subject and control details, related to the content and environment, in accordance with the degree of concentration shown by the concentration level information. When the user is not so much concentrating, it is possible to permit emergency notifications or high priority notifications.

As an example, in a case where the degree of concentration shown by the concentration level information is not less than a first threshold P1, the control section 23 judges the degree of concentration to be HIGH. In a case where the degree of concentration is less than the first threshold P1 and also not less than a second threshold P2, the control section 23 judges the degree of concentration as MID. Moreover, in a case where the degree of concentration is less than the second threshold P2, the control section 23 judges the degree of concentration as LOW.

For example, in a case where the degree of concentration is HIGH, the control section 23 controls each unit and the peripheral apparatuses of the information processing device 100, to prohibit any intercom call, phone call, or email notification thoroughly. In a case where the degree of concentration is MID, the control section 23 permits the intercom calls and the phone calls, and prohibits the email notifications. In a case where the degree of concentration is LOW, the control section 23 permits all the intercom calls, phone calls, and email notifications. Thus, it is possible for the information processing device 100 to perform control suitable for the concentration condition of the user.

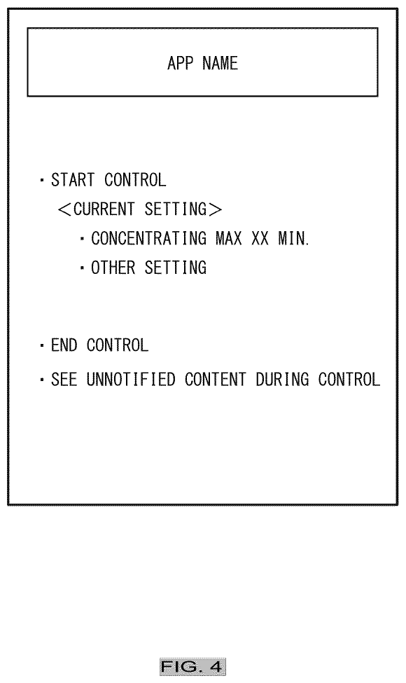

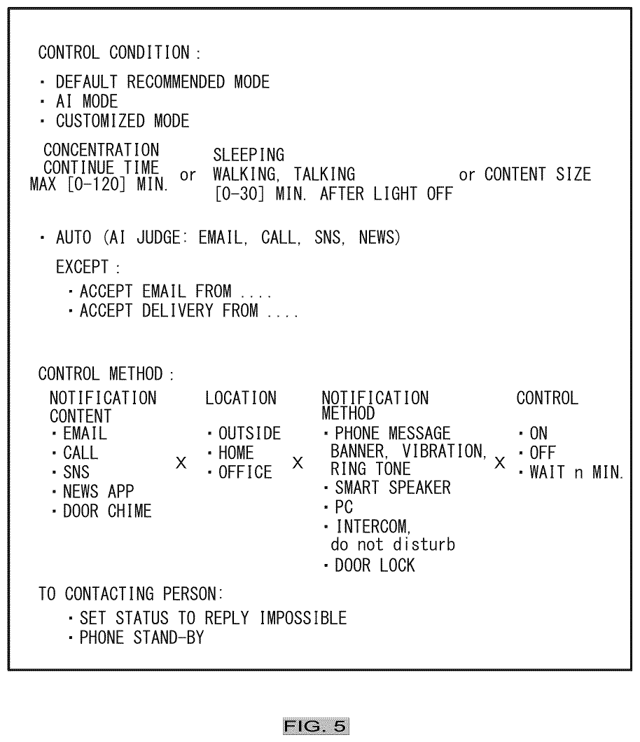

FIG. 4 to FIG. 6 are views illustrating examples of images displayed by the display unit of the information processing device according to the embodiment. For example, it is possible for the user to use an application software executed on the information processing device 100 as a user interface, to perform various types of control of the information processing device 100. FIG. 4 to FIG. 5 schematically show the examples of a setting screen. Note that, it is also possible for the display section 40a to perform UI display by using icons.

In the example as illustrated in FIG. 4, it is possible to select among “Start Control,” “End Control,” and “See Unnotified Content During Control.” By selecting “Start Control,” the control of the output of content starts. Moreover, in the example as illustrated in FIG. 4, the time for “Concentration Max” is set, as the time for suspending the output of content. By selecting “End Control” during the period of suspension of the output of content, the control of the output of content ends. Note that, by selecting “See Unnotified Content During Control,” it is possible for the user to confirm the details of unnotified emails or the like, during the period of suspension of the output of content.

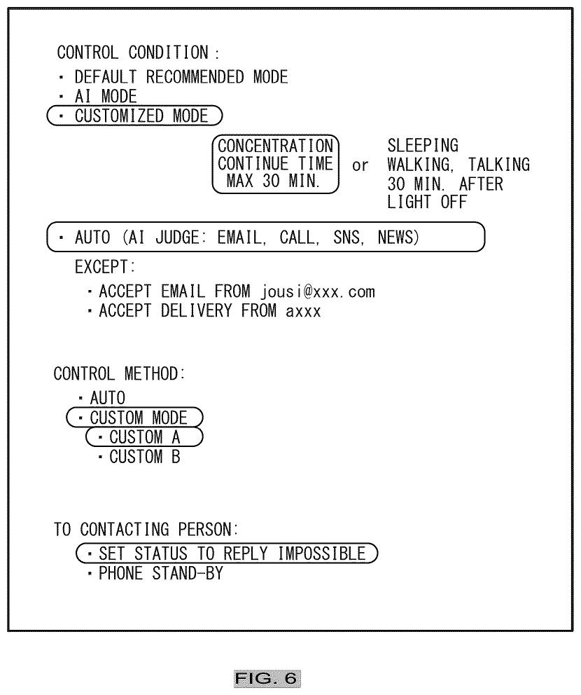

As illustrated by the examples of FIG. 5 and FIG. 6, it is possible for the display section 40a to display images related to the time for suspending the output of content, images related to the suspended content, or the like. It is possible for the user to customize and set notifications and environments subject for the control, the period for controlling, or the like. Moreover, it is also possible for the user to select a mode in which the control subject, the control period, or the like, are set automatically (AI mode). In the AI mode, it is also possible for the control section 23 to automatically adjust the time for suspending or restricting the output of content, on a basis of the brief history of past degree of concentration.

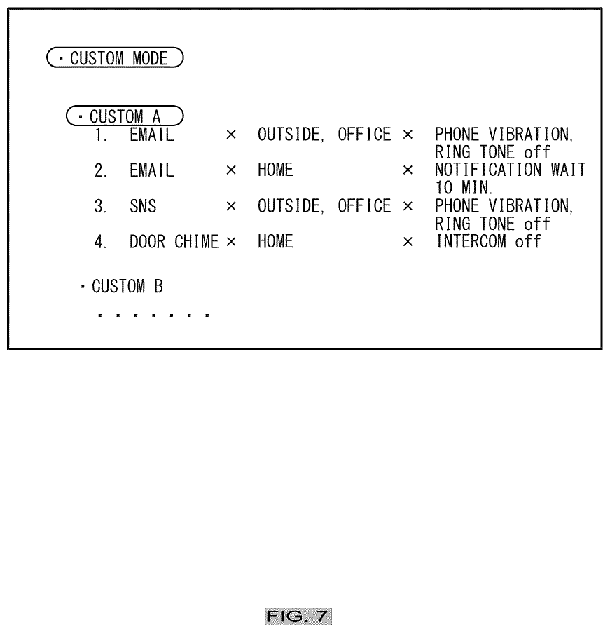

In the example as illustrated in FIG. 6, “Customized Mode,” which allows the change of control subject, control period, or the like, has been selected. By setting “Concentration Continue Time Max 30 Min.,” the upper limit time for suspending the output of content is set to 30 minutes. Moreover, in the example as illustrated in FIG. 6, “Custom A” of “Custom Mode” is selected as the control method. In this case, as illustrated in an example of FIG. 7, for example, the methods for controlling email, SNS, door chime, or the like, are set corresponding to each of the locations of the user (going out, office, home, or the like), that is the setting of control method according to “Custom A.” Thus, according to the present embodiment, it is possible to perform suitable control in accordance with the conditions and state of the user.

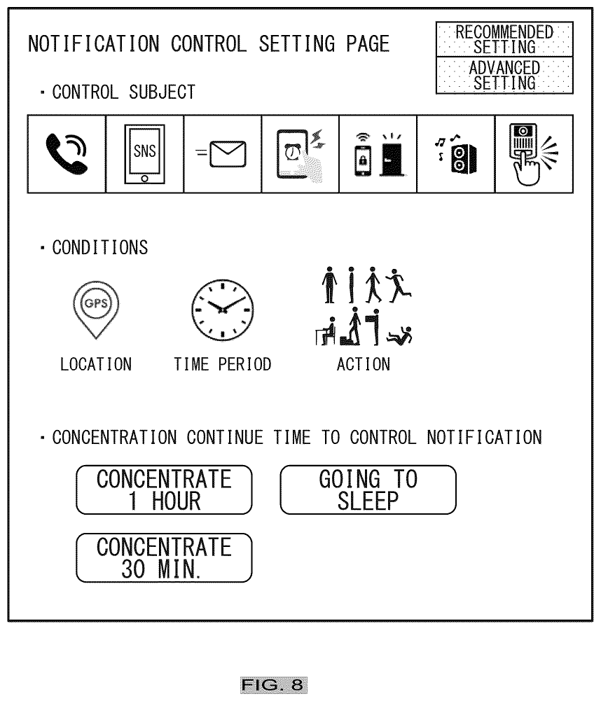

FIG. 8 is a diagram illustrating another example of image displayed by the display unit of the information processing device according to the embodiment. FIG. 8 schematically illustrates an example of setting screen. As illustrated in the example of FIG. 8, it is also possible for the display section 40a to perform UI display by using icons. The display section 40a displays images related to the control subject, images related to applicable conditions (location, period of time, action, or the like), images related to the period of time for performing control, or the like. It is possible for the user to set notifications and environments subject for the control, the applicable conditions, or the like, on the UI display screen. In the example as illustrated in FIG. 8, it is possible for the user to set the period of time for controlling notifications, by selecting among “Concentrate 1 Hour,” “Concentrate 30 Min.,” or “Going to Sleep,” as the period of time in which the user wishes to control the notifications. Moreover, it is also possible for the user to select “Recommended Setting” on the UI display screen, and it is also possible to select “Advanced Setting” to set other functions.

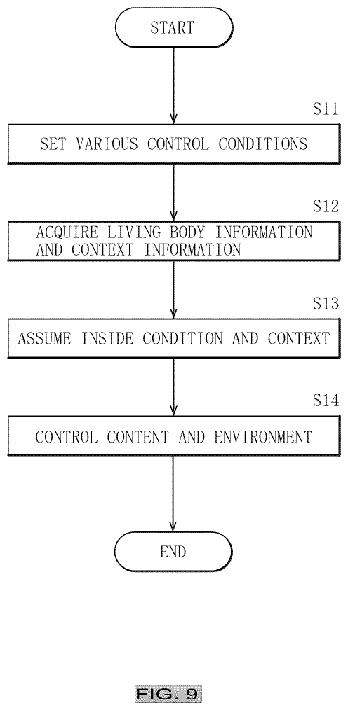

FIG. 9 is a flowchart illustrating an example of actions of the information processing device according to the embodiment. The example of actions of the information processing device 100 will be explained with reference to the flowchart of FIG. 9. The flow of FIG. 9 starts after activating the application software of the information processing device 100.

At step S11, the information processing device 100 sets various control conditions, in accordance with the operation of the operation unit 50 by the user, or in accordance with the selection by the information processing device 100. In the present case, the control subject of content and environment, the period of time for controlling, or the like, are set.

At step S12, the information processing device 100 outputs signals to the first sensor unit 70, to instruct measurement of a living body condition. Moreover, the information processing device 100 outputs signals to the second sensor unit 80, to instruct measurement of a context. In reply to the instruction (command) from the information processing device 100, the first sensor unit 70 starts measurement of the living body condition, and repeatedly generates the living body information. The second sensor unit 80 repeatedly generates the context information.

At step S13, the information processing device 100 assumes an internal condition of the user by using the living body information generated by the first sensor unit 70. In the present case, for example, the information processing device 100 assumes the degree of concentration of the user according to the concentration level information. The information processing device 100 assumes a context of the user by using the context information generated by the second sensor unit 80.

At step S14, the information processing device 100 controls the content, environment, or the like, in accordance with the assumed internal condition and context of the user. After finishing controlling of the content, environment, or the like, the information processing device 100 ends the processing as illustrated in the flowchart of FIG. 9.

### [Functions and Effects]

An information processing device (the information processing device 100) according to the present embodiment includes, an acquisition unit (the acquisition section 21) configured to acquire of a first information related to a living body (the living body information), a generation unit (the generation section 22) configured to generate of a second information related to the degree of concentration of the user (the concentration level information) on a basis of the first information, and a control unit (the control section 23) configured to control time to suspend the output of content on a basis of the second information.

The information processing device 100 according to the present embodiment controls the time to suspend the output of content on a basis of the concentration level information. Thus, it is possible to adjust the time to suspend the output of content in accordance with the degree of concentration, and to suppress obstruction against the concentration of the user. It is possible to realize the information processing device enabling execution of suitable control in accordance with the conditions of the user.

Next, modifications of the present disclosure will be explained. Hereinafter, with regard to elements substantially the same as those of the embodiment described above, the same reference signs and numbers will be allotted, and the explanations will be omitted whenever it seems fit.

### 2. Modification Examples

### [2-1. Modification Example 1]

It is also possible that the control section 23 of the information processing device 100 is configured to enable execution of processing to encourage change of control of content and environment, on a basis of the degree of concentration of the user. It is possible to encourage change of the time of control or change of the control subject in accordance with the concentration condition of the user, and to perform appropriate control.

For example, in a case where the user is not concentrating, it is possible for the control section 23 to output a voice message by the sound output section 40b, encouraging change of the time of control or change of the control subject. Moreover, for example, in a case where the user is not concentrating, it is also possible for the control section 23 to display an image on the display section 40a, encouraging change of the time of control or change of the control subject. Moreover, in a case where the user is not concentrating, it is also possible for the control section 23 to perform a vibration feedback or an illumination feedback (for example, vibration, light emission, or the like, of the information processing device 100).

It is possible for the user to change the time of control and/or the control subject, by confirming a voice message guide outputted by the sound output section 40b, an image guide displayed on the display section 40a, or the like. It is possible to reduce the number of subjects to be controlled, and/or to cancel control. In a case where non-concentrating time continues, it is also possible for the information processing device 100 to encourage the user to take a rest.

### [2-2. Modification Example 2]

Based on the living body information, the information processing device 100 assumes whether or not the user is in a pleasant state, and in a case where the user is in the pleasant state, it is also possible to perform the control of content and environment described above. For example, by using the living body information, the generation section 22 of the information processing device 100 is configured to judge whether or not the user is in the pleasant state, to generate information showing a result of judgment (first judgment information). As an example, by using information on brain wave (components of the alpha wave and the beta wave) included in the living body information, it is possible for the generation section 22 to judge whether or not the user is in the pleasant state, to generate the first judgment information.

It is known that, by making comparison between the alpha wave included in the brain wave acquired on the left side of the frontal region (hereinafter referred to as the left alpha wave), and the alpha wave included in the brain wave acquired on the right side of the frontal region (hereinafter referred to as the right alpha wave), the state of pleasant/unpleasant can be assumed. Thus, for example, in a case where the left alpha wave is lower than the right alpha wave, the generation section 22 may assume that the user is in the pleasant state. Further, in a case where the left alpha wave is higher than the right alpha wave, the user feels unpleasant, and the generation section 22 may assume that the user is in the unpleasant state.

It is also possible that, by using information on perspiration rate included in the living body information, the generation section 22 judges whether or not the user in in the pleasant state, to generate the first judgment information showing the result of judgment. It is also possible for the generation section 22 to assume whether or not the user is in the pleasant state, by comparing the perspiration rate with a reference value. For example, the generation section 22 may assume the pleasant/unpleasant state, by making comparison between a signal voltage corresponding to perspiration of the left hand, and a signal voltage corresponding to perspiration of the right hand. The generation section 22 repeatedly generates the first judgment information by using the living body information, or the like.

It is possible that, on a basis of the first judgment information, the control section 23 of the information processing unit 20 grasps whether or not the user is in the pleasant state, to control content, environment, or the like. In a case where the user is judged to be in the pleasant state, it is also possible for the control section 23 to start suspension of the output of content. In a case where the user is in the pleasant state, it is possible to suspend notifications, or the like, to the user. Note that, the method of judgment of pleasant/unpleasant is not limited to the above method.

Moreover, it is also possible that, the information processing device100 assumes whether or not the user is in a relaxed state on a basis of the living body information, and in a case where the user is in the relaxed state, the information processing device 100 controls the content, environment, or the like, described above. For example, by using the living body information, the generation section 22 of the information processing unit 20 is configured to judge whether or not the user is in the relaxed state, and to generate information showing a result of judgment (second judgment information). On a basis of the second judgment information, it is possible for the control section 23 to grasp whether or not the user is in the relaxed state, to perform control of content, environment, or the like. It is also possible that, in a case where the user is judged to be in the relaxed state, the control section 23 starts suspension of the output of content.

As described above, according to the present modification example, in a case where the user is in the pleasant state or the relaxed state, then notifications or the like to the user is suspended, and therefore, it is possible for the user to concentrate in work, entertainment experience, or the like. It is also possible that the control section 23 performs control of content, environment, or the like, on a basis of the concentration level information, the first judgment information, and the second judgment information. It is also possible that, in a case where the user is assumed to be concentrating, in the pleasant state, or in the relaxed state, then the control section 23 suspends notifications or the like to the user. In the present modified example, it is also possible to execute suitable control in accordance with the conditions of the user.

Although the present disclosure has been described with reference to the embodiment and the modification examples, the present disclosure is not limited to the above-described embodiments and the like, and various modifications are possible. For example, although the above modification examples have been explained as the modification examples of the above-described embodiment, it is possible to appropriately combine configurations of each modification example. Moreover, although the explanation has been made with reference to the human body as an example, it is also possible for the present disclosure to be applied to any living body other than the human body, for example, animals such as pets and livestock.

The information processing device according to one embodiment of the present disclosure includes, the acquisition unit configured to acquire of the first information related to the living body, the generation unit configured to generate of the second information related to the degree of concentration of the user on a basis of the first information, and the control unit configured to control time to suspend the output of content on a basis of the second information. Accordingly, it is possible to realize the information processing device enabling execution of suitable control in accordance with the conditions of the user.

Note that, the effects explained in the present Description is for a mere exemplification purpose, and is not limited to these explanations. Moreover, the present disclosure may also be configured as follows.

(1)

An information processing device including:
an acquisition unit configured to acquire of a first information related to a living body;
a generation unit configured to generate of a second information related to a degree of concentration of a user on a basis of the first information; and
a control unit configured to control time to suspend output of content on a basis of the second information.
   (2)

The information processing device according to (1), in which:
the control unit is configured to control time to start the suspension of the output of the content.
   (3)

The information processing device according to (1) or (2), in which:
the control unit is configured to control time to end the suspension of the output of the content.
   (4)

The information processing device according to any one of (1) to (3), in which:
the control unit is configured to control period of the suspension of the output of the content.
   (5)

The information processing device according to any one of (1) to (4), in which:
the control unit is configured to change the content to be suspended.
   (6)

The information processing device according to any one of (1) to (5), in which:
the control unit is configured to start the suspension of the output of the content on a basis of the second information.
   (7)

The information processing device according to any one of (1) to (6), in which:
the control unit starts the suspension of the output of the content in a case where the user is judged to be concentrating.
   (8)

The information processing device according to any one of (1) to (7), in which:
the control unit is configured to end suspension of output of content on a basis of the second information.
   (9)

The information processing device according to any one of (1) to (8), in which:
the control unit ends the suspension of the output of the content in a case where the user is judged not to be concentrating.
   (10)

The information processing device according to any one of (1) to (9), in which:
the control unit is configured to change the content to be suspended on a basis of the second information.
   (11)

The information processing device according to any one of (1) to (10), in which:
the control unit is configured to execute processing to encourage change of output control of the content on a basis of the second information.
   (12)

The information processing device according to any one of (1) to (11), in which:
the acquisition unit is configured to acquire a third information related to a condition of the user; and
the control unit is configured to control time to suspend the output of the content on a basis of the third information.
   (13)

The information processing device according to (12), in which:
the control unit is configured to control time to suspend the output of the content on a basis of the second information and the third information.
   (14)

The information processing device according to any one of (1) to (13), further including: an environment control unit configured to control surrounding environment of the user.

(15)

The information processing device according (14), in which:
the environment control unit is configured to control the surrounding environment of the user on a basis of the second information.
   (16)

The information processing device according to any one of (1) to (15), further including:
a sensor configured to generate the first information, in which:
the acquisition unit is configured to acquire the first information from the sensor.
   (17)

The information processing device according to any one of (1) to (16), further including:
a display unit configured to display of an image, in which:
the display unit is configured to display the image related to time to suspend the output of the content.
   (18)

The information processing device according (17), in which:
the display unit is configured to display at least one of the image related to the content to be suspended or the image related to a degree of concentration of the user.
   (19)

The information processing device according to any one of (1) to (18), in which:
the control unit starts the suspension of the output of the content in a case where the user is judged to be in a pleasant state.
   (20)

The information processing device according to any one of (1) to (19), in which:
the control unit is configured to control time to suspend the output of the content on a basis of a brief history of a degree of concentration of the user.

The present application claims the benefit of Japanese Priority Patent Application JP 2022-101209 filed with the Japan Patent Office on Jun. 23, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An information processing device comprising:
an acquisition unit configured to acquire a first information related to a living body;
a generation unit configured to generate a second information related to a degree of concentration of a user on a basis of the first information; and
a control unit configured to control time to suspend output of content on a basis of the second information.

2. The information processing device according to claim 1, wherein:
the control unit is configured to control time to start the suspension of the output of the content.

3. The information processing device according to claim 1, wherein:
the control unit is configured to control time to end the suspension of the output of the content.

4. The information processing device according to claim 1, wherein:
the control unit is configured to control period of the suspension of the output of the content.

5. The information processing device according to claim 1, wherein:
the control unit is configured to change the content to be suspended.

6. The information processing device according to claim 1, wherein:
the control unit is configured to start the suspension of the output of the content on a basis of the second information.

7. The information processing device according to claim 6, wherein:
the control unit starts the suspension of the output of the content in a case where the user is judged to be concentrating.

8. The information processing device according to claim 1, wherein:
the control unit is configured to end suspension of output of content on a basis of the second information.

9. The information processing device according to claim 8, wherein:
the control unit ends the suspension of the output of the content in a case where the user is judged not to be concentrating.

10. The information processing device according to claim 1, wherein:
the control unit is configured to change the content to be suspended on a basis of the second information.

11. The information processing device according to claim 1, wherein:
the control unit is configured to execute processing to encourage change of output control of the content on a basis of the second information.

12. The information processing device according to claim 1, wherein:
the acquisition unit is configured to acquire a third information related to a condition of the user; and
the control unit is configured to control time to suspend the output of the content on a basis of the third information.

13. The information processing device according to claim 12, wherein:
the control unit is configured to control time to suspend the output of the content on a basis of the second information and the third information.

14. The information processing device according to claim 1, further comprising:
an environment control unit configured to control surrounding environment of the user.

15. The information processing device according to claim 14, wherein:
the environment control unit is configured to control the surrounding environment of the user on a basis of the second information.

16. The information processing device according to claim 1, further comprising:
a sensor configured to generate the first information, wherein:
the acquisition unit is configured to acquire the first information from the sensor.

17. The information processing device according to claim 1, further comprising:
a display unit configured to display of an image, wherein:
the display unit is configured to display the image related to time to suspend the output of the content.

18. The information processing device according to claim 17, wherein:
the display unit is configured to display the image related to the content to be suspended.

19. The information processing device according to claim 1, wherein:
the control unit starts the suspension of the output of the content in a case where the user is judged to be in a pleasant state.

20. The information processing device according to claim 1, wherein:
the control unit is configured to control time to suspend the output of the content on a basis of a brief history of a degree of concentration of the user.
